(19) United States
(12) Patent Application Publication
(10) Pub. No.: US 2025/0103319 A1
(43) Pub. Date: Mar. 27, 2025

(54) PARTITION SYNCHRONIZATION METHOD FOR REDUNDANT UPDATE AND DEVICE FOR IMPLEMENTING SAME

(71) Applicant: Hyundai AutoEver Corp., Seoul (KR)

(72) Inventor: Deok Joo LEE, Seoul (KR)

(21) Appl. No.: 18/891,563

(22) Filed: Sep. 20, 2024

(30) Foreign Application Priority Data
Sep. 22, 2023 (KR) 10-2023-0126802

(51) Int. Cl. G06F 8/65

(52) U.S. Cl. CPC G06F 8/65

(57) ABSTRACT

A partition synchronization method in redundant update for updating a new version part in an execution controller operated redundantly with a first partition and a second partition includes generating first synchronization information and recording the first synchronization information along with a first new version part in one area of the first partition, and removing a difference from the first new version part using the first synchronization information and recording the difference-removed first new version part in one area of the second partition as a second new version part.

### CROSS REFERENCE TO RELATED APPLICATION

This application claims the benefit of and priority to Korea Patent Application No. 10-2023-0126802, filed on Sep. 22, 2023, the entire disclosure of which is hereby incorporated herein by reference in its entirety.

### FIELD OF TECHNOLOGY

The present disclosure relates to a redundant update technique, and more specifically, to a partition synchronization technique for redundant update of a non-MMU type MCU for vehicles.

### BACKGROUND

As electrification of vehicles is accelerated for the convenience and safety of vehicle drivers and passengers, the types of vehicle controllers are diversified and the functions of vehicle controllers are advanced. A vehicle controller needs to be updated to correct errors in the vehicle controller, improve performance, enhance security, add new functions, and apply new services.

Vehicle controller update can be performed by downloading the latest version file from a vehicle controller update server through a wireless communication network and transmitting the downloaded latest version file to a vehicle controller through an in-vehicle network.

There are various vehicle update methods, such as a full update method, a partial update method, a compressed update method, and a differential update method, an appropriate update method is selected depending on the environment or necessary conditions of vehicle update, and update can be performed according to the selected update method.

### PRIOR ART DOCUMENT

### Patent Document

(Patent Document 1) Korean Patent Publication No. 10-2020-0060943 (publication data 2020 Jun. 2)

The discussions in this section are only to provide background information and do not constitute an admission of prior art.

### SUMMARY

An object of the present disclosure is to provide a partition synchronization method in redundant update that utilizes a difference between images between redundant partition areas as synchronization information, and a device for implementing the same.

Another object of the present disclosure is to provide a partition synchronization method in redundant update that removes a difference from an image of one redundant partition area using synchronization information and copies the same to an area of another partition, and a device for implementing the same.

Another object of the present disclosure is to provide a partition synchronization method in redundant update that is not able to be performed in a conventional non-MMU type MCU redundant update, and a device for implementing the same.

The objects of the present disclosure are not limited to the objects mentioned above, and other objects that are not mentioned above will be clearly understood by those skilled in the art of the present disclosure from the description below.

To achieve the aforementioned objects, a partition synchronization method in redundant update according to an embodiment of the present disclosure is a method of updating a new version part in an execution controller operated redundantly with a first partition and a second partition, the partition synchronization method including generating first synchronization information and recording the first synchronization information along with a first new version part in one area of the first partition, and removing a difference from the first new version part using the first synchronization information and recording the difference-removed first new version part in one area of the second partition as a second new version part.

In an embodiment, the one area of the first partition may correspond to the one area of the second partition.

In an embodiment, the first partition may include a plurality of areas, the one area of the first partition may include at least one of the plurality of areas of the first partition, the second partition may include a plurality of areas, and the one area of the second partition may include at least one of the plurality of areas of the second partition.

In an embodiment, the first partition may be an inactive partition and the second partition may be an active partition.

In an embodiment, the generating first synchronization information and recording the first synchronization information along with a first new version part in one area of the first partition may include generating the new version part including a new version part for the first partition and a new version part for the second partition, and providing the new version part for the first partition as the first new version part.

In an embodiment, the generating first synchronization information and recording the first synchronization information along with a first new version part in one area of the first partition may include generating the first synchronization information, which is a partition cross-difference due to a change from the first partition to the second partition, and providing the first synchronization information along with the first new version part.

In an embodiment, the partition synchronization method may further include generating second synchronization information from a difference between the first new version part and the second new version part and recording the second synchronization information along with the second new version part in one area of the second partition.

In an embodiment, the second synchronization information may be a partition cross-difference due to a change from the second partition to the first partition.

In an embodiment, the execution controller may be a microcontroller unit (MCU) of a non-memory management unit (MMU) type.

In an embodiment, the partition synchronization method may further include removing a difference from an old version part of another area of the second partition using synchronization information and recording the difference-removed version part in another area of the first partition to synchronize the other area of the second partition and the other area of the first partition.

In an embodiment, the synchronization information may be a partition cross-difference due to a change from the second partition to the first partition.

To achieve the aforementioned objects, a computing device according to an embodiment of the present disclosure is a computing device implementing a partition synchronization method in redundant update for updating a new version part in an execution controller operated redundantly with a first partition and a second partition, the computing device including one or more processors, a communication interface configured to communicate with an external device, a memory configured to load a computer program executed by the processor, and a storage device in which the computer program is stored, wherein the computer program includes instructions for performing an operation of generating first synchronization information and recording the first synchronization information along with a first new version part in one area of the first partition, and an operation of removing a difference from the first new version part using the first synchronization information and recording the difference-removed first new version part in one area of the second partition as a second new version part.

In an embodiment, the first partition may be an inactive partition and the second partition may be an active partition.

In an embodiment, the first partition may include a plurality of areas, the one area of the first partition may include at least one of the plurality of areas of the first partition, the second partition may include a plurality of areas, the one area of the second partition may include at least one of the plurality of areas of the second partition, and the plurality of areas of the first partition may correspond to the plurality of areas of the second partition.

In an embodiment, the operation of generating first synchronization information and recording the first synchronization information along with a first new version part in one area of the first partition may include an operation of generating the new version part including a new version part for the first partition and a new version part for the second partition, and providing the new version part for the first partition as the first new version part.

In an embodiment, the instructions may further preform an operation of generating second synchronization information from a difference between the first new version part and the second new version part and recording the second synchronization information along with the second new version part in one area of the second partition, and the second synchronization information may be a partition cross-difference due to a change from the second partition to the first partition.

In an embodiment, the instructions may further perform an operation of removing a difference from an old version part of another area of the second partition using synchronization information and recording the difference-removed version part in another area of the first partition to synchronize the other area of the second partition and the other area of the first partition.

In an embodiment, the synchronization information may be a partition cross-difference due to a change from the second partition to the first partition.

In an embodiment, the execution controller is a microcontroller unit (MCU) of a non-memory management unit (MMU) type.

According to the present embodiment, it is possible to provide a partition synchronization method in redundant update that utilizes a difference between images between redundant partition areas as synchronization information, and a device for implementing the same.

According to the present embodiment, it is possible to provide a partition synchronization method in redundant update that removes a difference from an image of one redundant partition area using synchronization information and copies the same to an area of another partition, and a device for implementing the same.

According to the present embodiment, it is possible to provide a partition synchronization method in redundant update that is not able to be performed in a conventional non-MMU type MCU redundant update, and a device for implementing the same.

In addition, various effects can be provided that are directly or indirectly understood through this specification.

### BRIEF DESCRIPTION OF THE DRAWINGS

In order that the disclosure may be well understood, there are now described various forms thereof, given by way of example, reference being made to the accompanying drawings, in which:

FIG. 1 is a diagram illustrating a network environment for partition synchronization in redundant update of an execution controller according to an embodiment of the present disclosure;

FIG. 2 is a block diagram configuration diagram illustrating memory data structures of a management controller and an execution controller according to an embodiment of the present disclosure;

FIG. 3 is a diagram illustrating characteristics of non-MMU redundant update data according to an embodiment of the present disclosure;

FIG. 4 is a flowchart illustrating a partition synchronization method in redundant update of an execution controller according to an embodiment of the present disclosure;

FIG. 5 to FIG. 8 are diagrams illustrating the flowchart of the partition synchronization method in redundant update of the execution controller according to an embodiment of the present disclosure;

FIG. 9 is an exemplary diagram illustrating that the partition synchronization method in redundant update of a non-MMU type execution controller according to an embodiment of the present disclosure can solve conventional problems; and

FIG. 10 is a hardware configuration diagram of an exemplary computing device that can implement the partition synchronization method in redundant update according to several embodiments of the present disclosure.

### DETAILED DESCRIPTION

Hereinafter, embodiments of the present disclosure are described in detail with reference to the accompanying drawings. Advantages and characteristics of the present disclosure and methods to achieve them should be more clearly understood by referring to the accompanying drawings and the below described embodiments. However, the present disclosure is not limited to the below disclosed embodiments, but may be implemented in various types different from each other. The embodiments are provided only for completing the present disclosure and for completely teaching the scope of the present disclosure to a person having ordinary skill in the art to which the present disclosure pertains. The present disclosure is defined only by the scope of the claims and their equivalents.

In adding reference signs to components in each figure, it should be noted that the same components are denoted by the same signs as much as possible even if they are shown on different figures. In describing the present disclosure, a detailed description of a well-known configuration or function related the present disclosure has been omitted where it was determined that the detailed description would unnecessarily obscure the gist of the present disclosure.

All terms (including technical or scientific terms) used in this specification have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner. The terms used in this specification is for the purpose of describing embodiments only and is not intended to limit the present disclosure. In this specification, the singular expression includes the plural expression unless the context clearly dictates otherwise.

The terms “first”, “second”, A, B, (a), (b), etc. may be used herein to describe various elements of the present disclosure. These terms are only used to distinguish one element from another element and essential, order, or sequence of corresponding elements are not limited by these terms. It will be understood that when one element is referred to as being “connected to”, “coupled to”, or “access” another element, one element may be “connected to”, “coupled to”, or “access” another element via a further element although one element may be directly connected to or directly access another element.

The terms “comprise” and/or “comprising” used in the specification specify the presence of stated components, steps, operations, and/or elements, but do not preclude the presence or addition of one or more other components, steps, operations, and/or elements.

Hereinafter, some embodiments of the present disclosure will be described in detail with reference to the attached drawings.

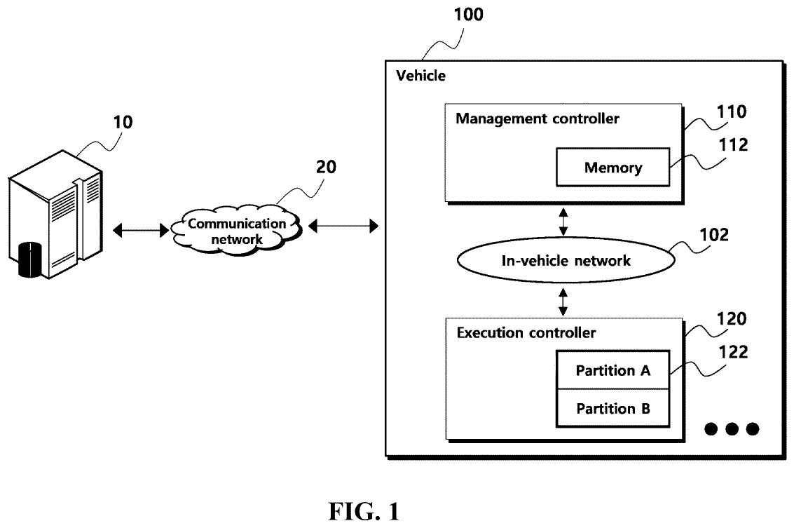

FIG. 1 is a diagram illustrating a network environment for partition synchronization in redundant update of an execution controller according to an embodiment of the present disclosure.

Referring to FIG. 1, the network environment for partition synchronization in redundant update of the execution controller may include an update server 10, a communication network 20, and a vehicle 100.

The update server 10 may store and manage control files for each vehicle and each execution controller. The files for each vehicle and each execution controller may include an old version file and a new version file. The old version file is a current version file currently being operated in the execution controller, and the new version file is a latest version file containing information to be updated and may be a higher version file than the old version file. The new version file may include a program necessary to correct errors in a vehicle controller, improve performance, reinforce security, add new functions, and apply new services, and data necessary to execute the program.

The update server 10 may register a new version file provided by a vehicle manufacturer as a new version file. The update server 10 may transmit the new version file to a management controller 110 through the communication network 20 and may also transmit the new version file to the management controller 110 through the communication network 20 at the request of the management controller 110.

The communication network 20 may be an external wireless network that allows the management controller 110 to download a new version file from the update server 10. As an example, the communication network 20 may include a mobile communication network, a wireless Internet network, and a local area communication network. The mobile communication network may include a mobile communication network constructed in accordance with technical standards or a communication method for mobile communication.

The vehicle 100 may be configured to include the management controller 110, an in-vehicle network 102, and an execution controller 120. The vehicle 100 may include an electric vehicle (EV) or a plug-in hybrid vehicle (PHEV) that is supplied with electricity by charging electricity from an external source.

The management controller 110 may download a new version file from the update server 10 through a communication network 20 and update the execution controller 120. The management controller 110 may be a high-performance application processor (AP).

As an example, the management controller 110 may download a new version file from the update server 10 through the communication network 20 and update the execution controller 120 through a partial update method. The partial update method is a method of updating the execution controller 120 by transmitting only parts of the new version file that have changed from the old version, and may be an efficient update method since only changed sectors are updated and thus there is no need to download the entire file.

The in-vehicle network 102 may be an in-vehicle communication network used when the management controller 110 updates the execution controller 102 with a new version file. For example, the in-vehicle network 101 may include a controller area network (CAN), a local interconnect network (LIN), FlexRay, a Media Oriented Systems Transport (MOST), and the like.

The execution controller 120 may receive the latest new version file from the management controller 110 through the in-vehicle network 101 and update the current old version file to the latest new version file. There may be a plurality of execution controllers 120 which controls electrical devices in the vehicle 100. For example, the execution controller 120 may include an engine control unit (ECU), a transmission control unit (TCU), an integrated body control unit (IBU), a battery management system (BMS), and an Idle Stop & Go (ISG) system. The electrical devices may be electrical and electronic devices mounted in the vehicle for the operation of the vehicle and the convenience and safety of a vehicle operator. For example, the electrical devices may be electrical and electronic devices related to the power train, the body, the chassis, the in-vehicle network, multimedia, etc. of the vehicle.

As an example, the execution controller 120 may be a non-memory management unit (MMU) type microprocessor unit (MCU). If the execution controller 120 is a non-MMU type, the execution controller 120 may include a partitioned memory 122 for redundant operation.

For example, the memory 122 of the execution controller 120 may be partitioned into partition A and partition B and used separately. Partition A may include a plurality of areas, partition B may include a plurality of areas, and the plurality of areas of partition A may correspond to the plurality of areas of partition B.

As an example, the memory 122 of the execution controller 120 may be a flash memory. Since the flash memory has a characteristic in which write and erase operations are performed based on an area of a specific size, update may be performed on the area of the specific size. The area of thea specific size may be a sector or a block of the flash memory and may be the same size as each area of partition A and partition B.

As an example, the management controller 110 may generate new version partial images (in binary form) related to two partition addresses in advance and store the same in the memory 112. This may be because, when the execution controller 120 is a non-MMU type, it is impossible to switch memory addresses in hardware unlike a case where the execution controller 120 is an MMU type.

For example, the management controller 110 may generate a new version part (binary form) for partition A of the execution controller 120 and a new version part (binary form) for partition B from a new version file downloaded from the update server 10 and store the new version parts in the memory 112.

The management controller 110 and the execution controller 120 may be integrated with the vehicle 100 or may be implemented in a form in which they are manufactured as separate components from the vehicle 100 and installed in or attached to the vehicle 100. In addition, parts of the management controller 110 and the execution controller 120 may be integrated with the vehicle 100 and the remaining parts may be implemented in a form in which they are manufactured as separate components from the vehicle 100 and installed in or attached to the vehicle.

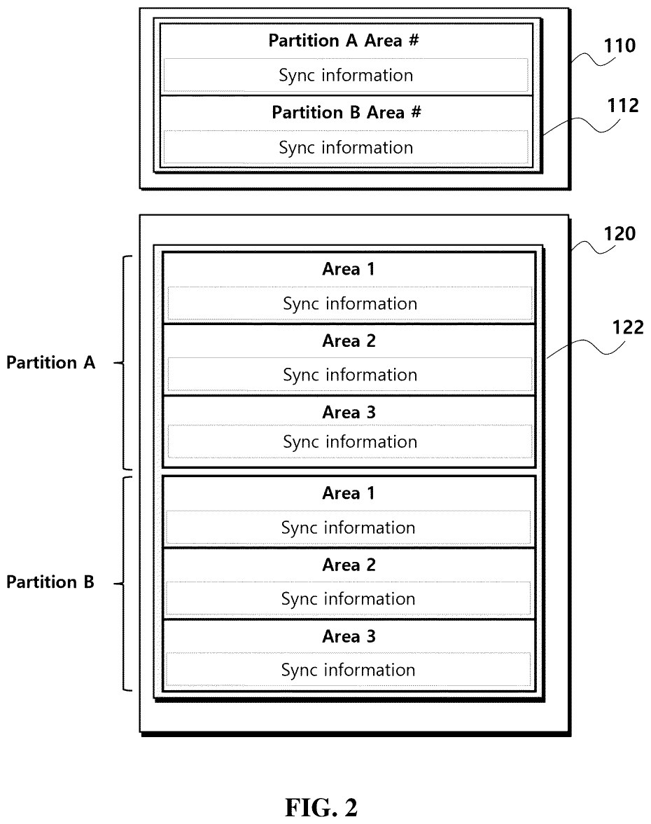

FIG. 2 is a block configuration diagram illustrating memory data structures of the management controller and the execution controller according to an embodiment of the present disclosure.

Referring to FIG. 2, as an example, the memory 112 of the management controller 110 may store an image for partition A and an image for partition B generated from a new version partial image by the management controller 110. The image for partition A and the image for partition B may include synchronization information Sync for synchronizing the images each other. The synchronization information Sync is information for copying images such that the image for partition A and the image for partition B can be operated in different partitions, and may be a partition cross-difference or a mutually opposite partition difference due to a mutual change between partition A and partition B.

The synchronization information Sync of partition A may be a difference from partition A to partition B which enables the image for partition A to be operated in partition B, and the synchronization information of partition B may be a difference from partition B to partition A which enables the image for partition B to be operated in partition A.

For example, the memory 112 of the management controller 110 may store a new version part (including synchronization information) to be updated in an area Area #of partition A and a new version part (including synchronization information) to be updated in an area Area #of partition B. The synchronization information of the area Area #of partition A may be a difference from an image of the area Area #of partition A to an image of the area Area #of partition B. The synchronization information of the area Area #of partition B may be a difference from an image of the area Area #of partition B to an image of the area Area #of partition A.

As an example, the memory 122 of the execution controller 120 may be partitioned into partition A and partition B and used separately. Partition A includes a plurality of areas, partition B includes a plurality of areas, and the plurality of areas of partition A may correspond to the plurality of areas of partition B.

For example, partition A of the memory 122 of the execution controller 120 may store three areas Area1, Area2, and Area3 and synchronization information Sync in each area, and partition B of the memory 122 of the execution controller 120 may store three areas Area1, Area2, and Area3 and synchronization information Sync in each area.

As an example, the synchronization information Sync of each area Area1, Area2, and Area3 of partition A may be a difference from partition A to partition B, and the synchronization information Sync of each area Area1, Area2, and Area3 of partition B may be a difference from partition B to partition A.

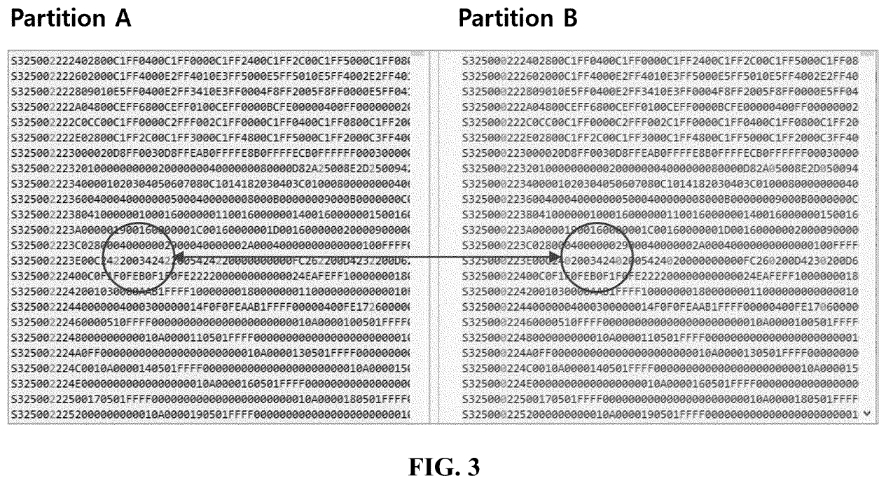

FIG. 3 is a diagram for describing characteristics of non-MMU redundant update data according to an embodiment of the present disclosure.

FIG. 3 illustrates comparison between a new version partial image to be updated in one area of partition A with a new version partial image to be updated in one area of partition B. The difference between the new version partial image of partition A and the new version partial image of partition B is a difference in mapped address information and is very small.

This will be described in more detail by explaining a method using the MMU and a method using the non-MMU. First, if the execution controller is equipped with a memory management unit (MMU), hardware-based inter-partition memory address switching is possible, and thus an image can be downloaded as a single update image (in binary form).

However, according to an embodiment of the present disclosure, if the execution controller does not have an MMU, hardware-based inter-partition memory address switching is impossible, and thus it is necessary to generate two update images (in binary form) related to two memory partition addresses and download the update images to the respective partition areas.

At this time, although the two update images are compiled programs that perform substantially the same function, the two update images are operated at different addresses in the memory, i.e., partition A and partition B, respectively, and thus it can be ascertained that only address information allocated at the time of compilation is different. This suggests that the difference between the update images of partition A and partition B is a very small portion compared to the entire update image.

A partition synchronization method in redundant update of a non-MMU type MCU according to an embodiment of the present disclosure based on this point can use the difference between the updated images of partition A and partition B as synchronization information and synchronize the image of partition A with the image of partition B by removing the difference from the image of partition A using the synchronization information and copying the same as necessary. Conversely, the partition synchronization method can synchronize the image of partition B with the image of partition A by removing the difference from the image of partition B using the synchronization information and copying the same as necessary.

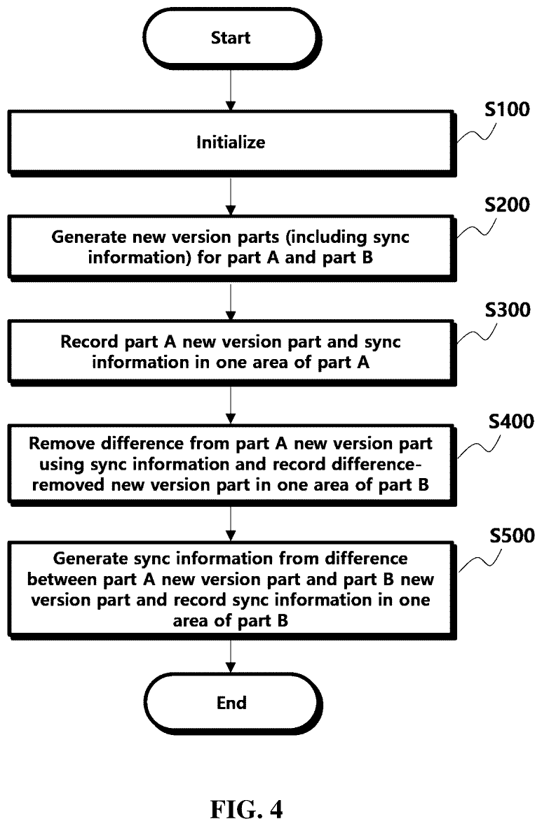

FIG. 4 is a flowchart illustrating the partition synchronization method in redundant update of the execution controller according to an embodiment of the present disclosure.

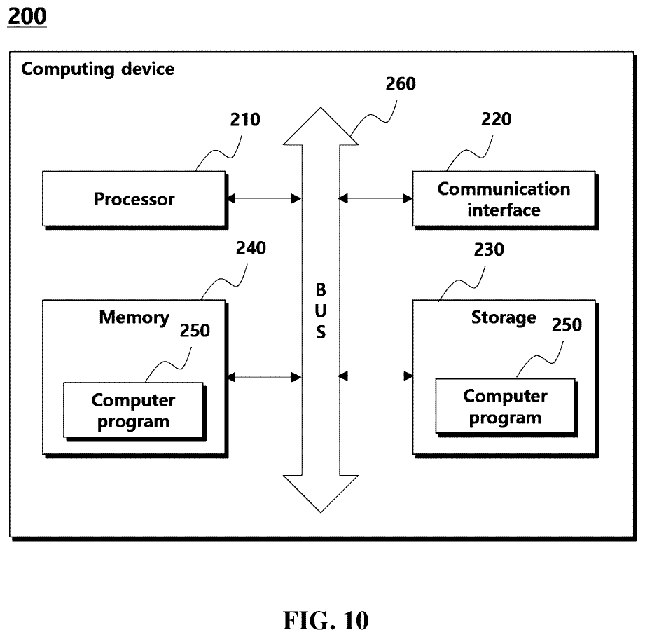

The partition synchronization method in redundant update of the execution controller according to an embodiment of the present disclosure may be executed by a computing device 200 illustrated in FIG. 10. The computing device 200 executing the method according to the present embodiment is a computing device having an application program execution environment and may be mounted on a vehicle for vehicle operation. The description of a subject performing some operations included in the method according to the embodiment of the present disclosure may be omitted, and in such a case, the subject may be the computing device 200.

Referring to FIG. 4, the partition synchronization method in redundant update of the execution controller according to an embodiment of the present disclosure may include an initialization step S100, a step S200 of generating new version parts for partition A and partition B, a step S300 of updating partition A, a step S400 of synchronizing partition B, and a step S500 of generating synchronization information of partition B.

The step S100 is an initialization step in which a specific version of an image is prepared in a state in which the image is redundantly loaded and operated in each partition in a memory of an execution controller including no MMU according to an embodiment of the present disclosure. If one partition is in an active state, the other partition may be in an inactive state.

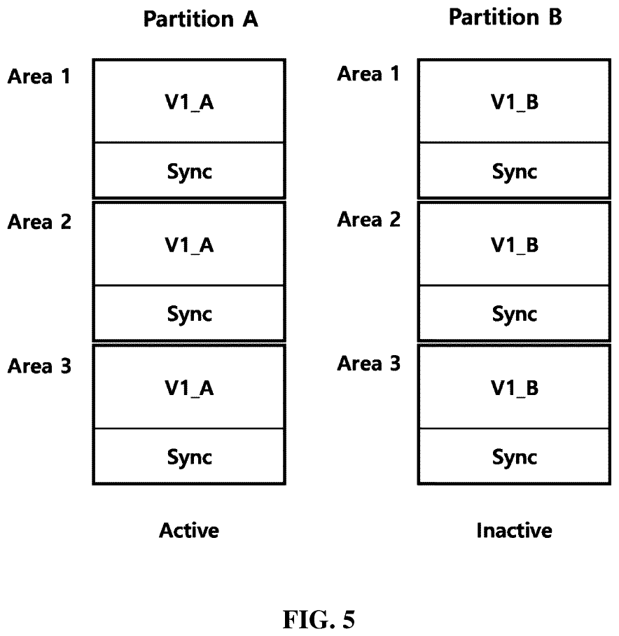

Referring to FIG. 5 as one embodiment, the step S100 may be a step in which the memory of the execution controller is prepared in a state in which it is redundantly operated in version 1 V1.

Specifically, the memory 122 of the execution controller may be partitioned into partition A and partition B, and partition A and partition B may each include three areas. Here, the three areas are examples for convenience of description, and partition A and partition B may include three or more areas.

A partial image V1_A of version 1 that may be operated in each area of partition A is recorded along with synchronization information Sync in each of areas 1, 2, and 3 of partition A, and a partial image V1_B of version 1 that may be operated in each area of partition B is recorded along with synchronization information Sync in each of areas 1, 2, and 3 of partition B such that version 1 V_1 can be redundantly operated in the execution controller as a whole. Partition A may be in an active state and partition B may be in an inactive state.

The step S200 may be a step of generating new version parts for partition A and partition B and may be a step in which the management controller 110 generates a new version partial image (including synchronization information) for each of partition A and partition B.

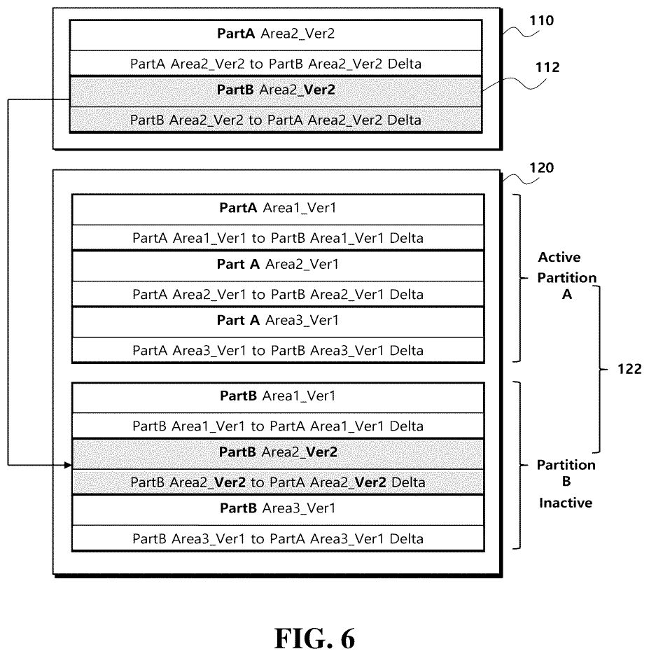

As an embodiment, referring to FIG. 6, the step S200 may be a step in which the management controller 110 generates a new version partial image and synchronization information for each of partition A and partition B.

More specifically, the management controller 110 may receive a partial image Area2 of a new version Ver2, which is updated from an old version Ver1 currently being operated by the execution controller 120, from the update server, and generate a new version partial image PartA Area2_Ver2 for partition A and a new version partial image PartB Area2_Ver2 for partition B from the partial image Area2 of the new version Ver2.

In addition, the management controller 110 may generate a difference from partition A to partition B (PartA Area2_Ver2 to PartB Area2_Ver Delta, synchronization information toB) and a difference from partition B to partition A (PartB Area2_Ver2 to PartA Area2_Ver Delta, synchronization information toA) by differentiating the new version partial image PartA Area2_Ver2 for partition A and the new version partial image PartB Area2_Ver2 for partition B.

The management controller 110 may include the synchronization information toB (PartA Area2_Ver2 to PartB Area2_Ver Delta) in the new version partial image PartA Area2_Ver2 for partition A and include the synchronization information toA (PartB Area2_Ver2 to PartA Area2_Ver Delta) in the new version partial image PartB Area2_Ver2 for partition B.

In the step S200, the management controller 110 may inquire of the execution controller 120 about an activate or inactive partition and determine the synchronization information toA (PartB Area2_Ver2 to PartA Area2_Ver Delta) in the new version partial image PartB Area2_Ver2 for partition B for the current inactive partition, for example, partition B, as a new version partial image to be downloaded to the execution controller 120.

The step S300 is a step of updating an area of partition A, and may be a step of recording the new version part of partition A and the synchronization information in an area of partition A.

As an embodiment, referring to FIG. 6, the step S300 may be a step in which the execution controller 120 downloads the synchronization information toA (PartB Area2_Ver2 to PartA Area2_Ver Delta) from the management controller 120 to the new version partial image PartB Area2_Ver2 of partition B and records the same in area 2 Area2 of partition B that is currently in an inactive state.

The step S400 may be a step of synchronizing partition B, and may be a step of removing the difference from the new version part updated in partition A using the synchronization information and recording the same in the corresponding area of partition B to synchronize partition B.

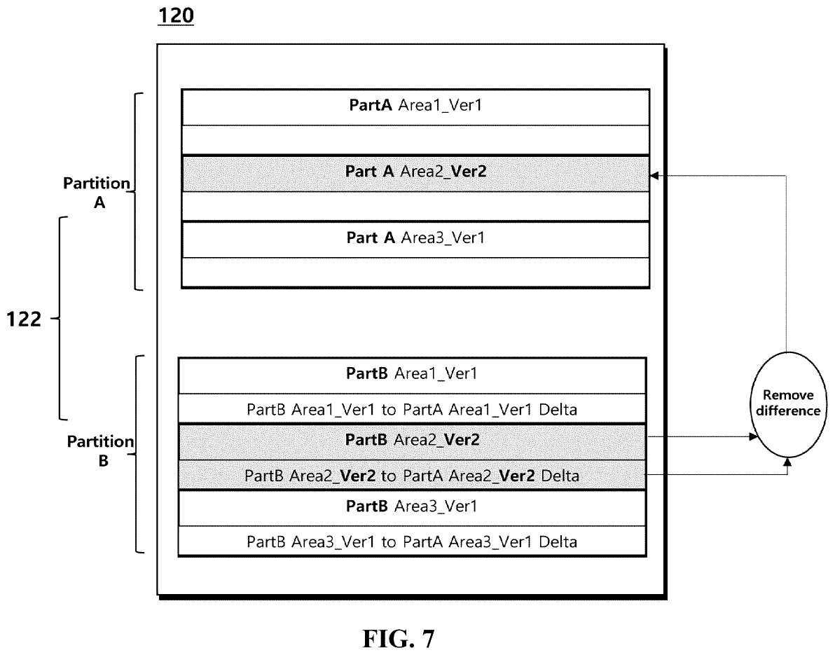

As an embodiment, referring to FIG. 7, the step S400 may be a step in which the execution controller 120 removes the difference from the new version partial image PartB Area2_Ver2 updated in area 2 Area2 of partition B using the synchronization information toA (PartB Area2_Ver2 to PartA Area2_Ver Delta) to generate an image for partition A PartA Area2_Ver2, and records the image for partition A to area 2 Area2 of partition A. The step S400 may be performed after partition B to which the new version partial image has been downloaded is activated through swap and partition A is inactivated.

The step S500 is a step of generating synchronization information for partition B, and may be a step of generating synchronization information from a difference between the new version part of partition A and the new version part of partition B and recording the same in an area of partition B.

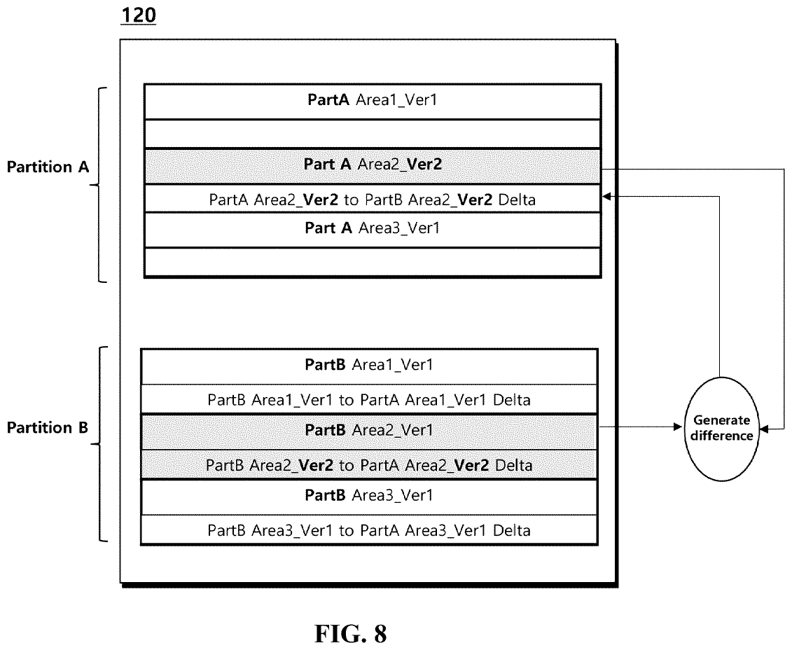

As an embodiment, referring to FIG. 8, the step S500 may be a step in which the execution controller 120 generates synchronization information toB (PartA Area2_Ver2 to PartB Area2_Ver2 Delta) from the difference between the new version partial image of partition A PartA Area2_Ver2 and the new version partial image of partition B PartB Area2_Ver2 in step S400 and recording the same in an area of partition B.

The synchronization information toB (PartA Area2_Ver2 to PartB Area2_Ver2 Delta) generated in step S500 may be used in a process of copying the image PartA Area2_Ver2 recorded in area 2 of partition A to area 2 of partition B 2 to synchronize the content recorded in area 2 of partition A with the content recorded in area 2 of partition B after step S500.

As an embodiment, in the step S500, another area of partition B may be synchronized with another area of partition A by removing the difference from the version partial image of the other area of partition B using the synchronization information and recording the same in the other area of partition A. For example, one area of partition A may be updated to a new version part, and other areas of partition A that have not been updated may be synchronized with other areas of partition B using the synchronization information.

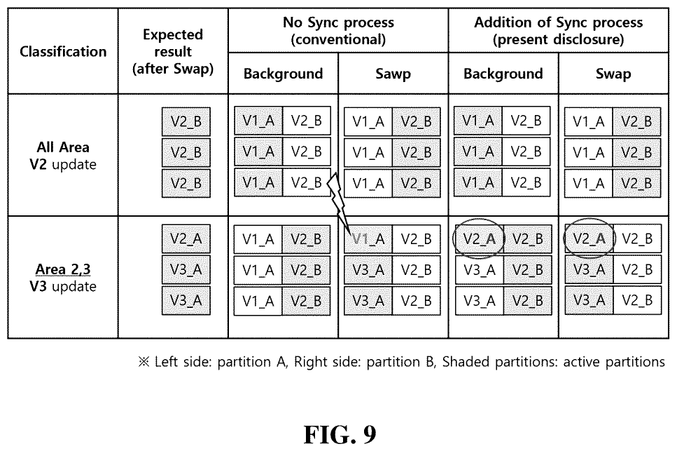

FIG. 9 is an exemplary diagram illustrating that the partition synchronization method in redundant update of a non-MMU type execution controller according to an embodiment of the present disclosure can solve conventional problems.

Referring to FIG. 9, the difference between the conventional method without the synchronization process of the execution controller and the present disclosure having the synchronization process added can be explained through the process of sequentially redundantly updating version 1 V1, version 2 V2, and version 3 V3. For reference, the left partition is partition

A and the right partition is partition B in two columns and three rows in the table, each partition is partitioned into three areas, and shaded partitions are active partitions.

First, a process of updating all areas of partitions to version 2 will be described.

In the backgrounds of the conventional method and the present disclosure, partitions A in which version V1_A is operating is active partitions, and thus version 2 can be downloaded to all areas of inactive partitions. Thereafter, if partitions B are activated through a swap process, the execution controller can run the upgraded version V2. After the swap, partitions B are operated in V2_B in both the conventional method and the present disclosure, which matches the expected result.

Next, a process of updating some areas of a partition to version 3 will be described.

In the conventional background, if partition B of version 2 V2_B is an active partition, and areas 2 and 3 of inactive partition A are upgraded to version 3 V3 and swapped to activate partition A, the expected result after the swap will not match. Specifically, area 1 of partition A should be operated in version 2 V2, but area 1 is not upgraded and may be operated in version 1 V1, resulting in an abnormal state.

On the other hand, in the background of the present disclosure, if partition B of version 2 V2_B is an active partition, and areas 2 and 3 of inactive partition A are upgraded to version 3 V3 and swapped to activate partition A, the expected result after the swap will match. Specifically, when areas 2 and 3 of partition A are upgraded to version 3 V3, area 1 of partition A, which is not upgraded, is copied to partition A by removing the difference from V2_B of partition B using synchronization information, thereby resolving the problem occurring in the conventional method.

In other words, if the partition synchronization method is not performed in redundant update of the non-MMU type execution controller according to an embodiment of the present disclosure, the version images of partition A and partition B are different from each other, and thus invalid execution images that cannot be executed are created when the version images are copied to the other partitions. However, if partition synchronization of the execution device is performed according to an embodiment of the present disclosure, an execution image that can be executed can be copied between areas of partition A and partition B when necessary.

FIG. 10 is a hardware configuration diagram of a computing device according to several embodiments of the present disclosure.

The computing device 200 illustrated in FIG. 10 may include one or more processors 210, a system bus 260, a communication interface 220, a memory 240 that loads a computer program 250 executed by the processor 210, and a storage 230 in which the computer program 250 is stored. Only components related to an embodiment of the present disclosure are illustrated in FIG. 10. Therefore, a person skilled in the art will appreciate that other general components may be included in addition to the components illustrated in FIG. 10.

The computing device 200 may be implemented as an electronic device mounted on a vehicle, for example.

The processor 210 may control the overall operation of each component of the computing device 200. For example, the processor 210 may be a component implemented in each electronic device for a vehicle and controlling the operation of the electronic device.

As an embodiment, the processor 210 may include a management controller and an execution controller. The execution controller may be a non-MMU (Memory Management Unit) type microcontroller unit (MCU).

In addition, the processor 210 may be configured to include at least one of a central processing unit (CPU), a microprocessor unit (MPU), a microcontroller unit (MCU), a graphics processing unit (GPU), or any type of processor well known in the technical field of the present disclosure. The processor 210 may perform operations with respect to at least one application or program to execute methods/operations according to various embodiments of the present disclosure. The computing device 200 may include one or more processors.

The memory 240 may store various types of data, commands, and/or information. The memory 240 may load one or more computer programs 250 from the storage 230 to execute methods/operations according to various embodiments of the present disclosure. For example, when the computer program 250 is loaded into the memory 240, a program logic or a program module may be implemented in a state in which it is executable by the processor 210 on the memory 240. The memory 240 may be a RAM, but is not limited thereto.

The bus 260 may provide a communication function between components of the computing device 200. The bus 260 may be implemented as various types of buses including an address bus, a data bus, and a control bus.

The communication interface 220 may include a communication module that supports wired and wireless Internet communication of the computing device 200 and various communication methods known in the technical field of the present disclosure.

The storage 230 may non-temporarily store one or more computer programs 250. The storage 230 may include a non-volatile memory such as a flash memory, a hard disk, a removable disk, or any form of computer-readable recording medium known in the art to which the present disclosure pertains.

The computer program 250 may include one or more instructions by which methods/operations according to various embodiments of the present disclosure are implemented. When the computer program 250 is loaded into the memory 240, the processor 210 may perform the methods/operations according to various embodiments of the present disclosure by executing one or more instructions.

As an embodiment, the computer program 250 may be a computer program that implements a partition synchronization method in redundant update of a non-MMU type MCU.

For example, the computer program 250 may include instructions for performing an operation of generating first synchronization information and recording the same along with a first new version part in one area of a first partition, and an operation of removing a difference from the first new version part using the first synchronization information and recording the same as a second new version part in one area of a second partition.

According to the present embodiment, it is possible to provide a partition synchronization method in redundant update which utilizes an image difference between redundant partition areas as synchronization information, and a device for implementing the same. In addition, according to the present embodiment, it is possible to provide a partition synchronization method in redundant update which removes a difference from an image of a redundant partition area using synchronization information and copies the same to an area of another partition, and a device for implementing the same. In addition, according to the present embodiment, it is possible to provide a partition synchronization method in redundant update which cannot be performed in redundant update of a conventional non-MMU type MCU, and a device for implementing the same.

Various embodiments of the present disclosure and effects according to the embodiments have been mentioned above with reference to FIG. 1 to FIG. 10. Effects according to the technical idea of the present disclosure are not limited to the effects mentioned above, and other effects that are not mentioned can be clearly understood by those skilled in the art from the description below.

The technical idea of the present disclosure described so far may be implemented as computer-readable code on a computer-readable medium. For example, the computer-readable recording medium may be a removable recording medium (a CD, a DVD, a Blu-ray disc, a USB storage device, or a removable hard disk) or a stationary recording medium (a ROM, a RAM, or a computer fixed hard disk). A computer program recorded on a computer-readable recording medium may be transmitted to another computing device through a network such as the Internet and installed on the other computing device, and thus can be executed and used on the other computing device.

Although operations are depicted in a specific order in the figures, it should not be understood that the operations must be executed in the specific order depicted or in a sequential order or that all the depicted operations must be executed to obtain a desired result, and in certain situations, multitasking and parallel processing may be advantageous. Furthermore, in the embodiments described above, various separations of components should not be construed as necessarily requiring such separation, and program components, program modules and systems may generally be integrated into a single software product or implemented as multiple software packages.

Although the embodiments of the present disclosure have been described with reference to the attached drawings, those skilled in the art to which the present disclosure pertains will understand that the present disclosure can be implemented in other specific forms without changing the technical ideas or essential characteristics thereof. Therefore, it should be understood that the embodiments described above are exemplary and not restrictive in all respects. The protection scope of the present disclosure should be interpreted by the following claims, and all technical ideas within a scope equivalent thereto should be interpreted as being included in the scope of rights of the technical ideas defined by the present disclosure.

What is claimed is:

1. A partition synchronization method in redundant update for updating a new version part in an execution controller operated redundantly with a first partition and a second partition, the partition synchronization method comprising:
generating first synchronization information and recording the first synchronization information along with a first new version part in one area of the first partition; and
removing a difference from the first new version part using the first synchronization information and recording the difference-removed first new version part in one area of the second partition as a second new version part.

2. The partition synchronization method of claim 1,
wherein the one area of the first partition corresponds to the one area of the second partition.

3. The partition synchronization method of claim 2,
wherein the first partition includes a plurality of areas, the one area of the first partition including at least one of the plurality of areas of the first partition, and
wherein the second partition includes a plurality of areas, the one area of the second partition including at least one of the plurality of areas of the second partition.

4. The partition synchronization method of claim 1,
wherein the first partition is an inactive partition and the second partition is an active partition.

5. The partition synchronization method of claim 4,
wherein the generating of the first synchronization information and the recording of the first synchronization information along with the first new version part in the one area of the first partition comprise:
generating the new version part including a new version part for the first partition and a new version part for the second partition; and
providing the new version part for the first partition as the first new version part.

6. The partition synchronization method of claim 5,
wherein the generating of the first synchronization information and the recording of the first synchronization information along with the first new version part in the one area of the first partition further comprises:
generating the first synchronization information, which is a partition cross-difference due to a change from the first partition to the second partition, and
providing the first synchronization information along with the first new version part.

7. The partition synchronization method of claim 1, further comprising:
generating second synchronization information from a difference between the first new version part and the second new version part and recording the second synchronization information along with the second new version part in the one area of the second partition.

8. The partition synchronization method of claim 7,
wherein the second synchronization information is a partition cross-difference due to a change from the second partition to the first partition.

9. The partition synchronization method of claim 1, wherein the execution controller includes a microcontroller unit (MCU) of a non-memory management unit (MMU) type.

10. The partition synchronization method of claim 1, further comprising:
removing a difference from an old version part of another area of the second partition using synchronization information and recording the difference-removed old version part in another area of the first partition to synchronize the another area of the second partition and the another area of the first partition.

11. The partition synchronization method of claim 10, wherein the synchronization information is a partition cross-difference due to a change from the second partition to the first partition.

12. A computing device implementing a partition synchronization method in redundant update for updating a new version part in an execution controller operated redundantly with a first partition and a second partition, the computing device comprising:
one or more processors;
a communication interface configured to communicate with an external device;
a memory configured to load a computer program executed by the one or more processors; and
a storage device storing the computer program,
wherein the computer program includes instructions for performing:
generating first synchronization information and recording the first synchronization information along with a first new version part in one area of the first partition; and
removing a difference from the first new version part using the first synchronization information and recording the difference-removed first new version part in one area of the second partition as a second new version part.

13. The computing device of claim 12,
wherein the first partition is an inactive partition and the second partition is an active partition.

14. The computing device of claim 12,
wherein the first partition includes a plurality of areas, the one area of the first partition including at least one of the plurality of areas of the first partition,
wherein the second partition includes a plurality of areas, the one area of the second partition including at least one of the plurality of areas of the second partition, and
wherein the plurality of areas of the first partition corresponds to the plurality of areas of the second partition.

15. The computing device of claim 14,
wherein the generating of the first synchronization information and the recording of the first synchronization information along with the first new version part in the one area of the first partition comprises generating the new version part including a new version part for the first partition and a new version part for the second partition, and providing the new version part for the first partition as the first new version part.

16. The computing device of claim 12,
wherein the instructions further preform generating second synchronization information from a difference between the first new version part and the second new version part and recording the second synchronization information along with the second new version part in the one area of the second partition,
wherein the second synchronization information is a partition cross-difference due to a change from the second partition to the first partition.

17. The computing device of claim 12,
wherein the instructions further perform removing a difference from an old version part of another area of the second partition using synchronization information and recording the difference-removed old version part in another area of the first partition to synchronize the another area of the second partition and the another area of the first partition.

18. The computing device of claim 17,
wherein the synchronization information is a partition cross-difference due to a change from the second partition to the first partition.

19. The computing device of claim 12,
wherein the execution controller includes a microcontroller unit (MCU) of a non-memory management unit (MMU) type.
